(19) United States
(12) Patent Application Publication
(10) Pub. No.: US 2022/0261319 A1
(43) Pub. Date: Aug. 18, 2022

(54) FAULT ISOLATION SYSTEM, METHOD AND PROGRAM

(71) Applicant: NEC Corporation, Minato-ku, Tokyo (JP)

(72) Inventor: Tatsuya FUKUDA, Tatsuya (JP)

(73) Assignee: NEC Corporation, Minato-ku, Tokyo (JP)

(21) Appl. No.: 17/618,608

(22) PCT Filed: Jun. 24, 2019
(86) PCT No.: PCT/JP2019/024919

§ 371 Date: Dec. 13, 2021

(51) Int. Cl. G06F 11/18

(52) U.S. Cl. CPC G06F 11/181; G06F 2201/805

(57) ABSTRACT

The configuration information generation unit 101, when given a set of constituent requirements, generates configuration information representing the system, by repeating operation of replacing the constituent requirement with a set of more concrete constituent requirements according to a replacement rule. The verification program generation unit 106 generates, for each constituent requirement, a verification program for verifying whether parts in the system corresponding to the constituent requirement in the configuration information are normal or not. The verification program execution unit 107 causes the system to execute the verification program. The fault isolation unit 109 separates the part in the system where a fault may have occurred from the part where the fault has not occurred, according to whether execution result of the verification program is success or not.

### TECHNICAL FIELD

The present invention relates to a fault isolation system, a fault isolation method, and a fault isolation program.

### BACKGROUND ART

A computer system, such as an ICT (Information and Communication Technology) system, is referred to herein as a system.

In constructing a system and providing the system to users, the system builder needs to construct the system by combining various products and technologies, and also needs to verify that the constructed system works properly.

However, with the development of information technology such as virtualization in recent years, the construction and control of systems have become more flexible, while the overall system is becoming larger and more complex. In addition, as the system becomes larger and more complex, it is becoming difficult to verify that the system operates properly.

An example of a general verification automation system is described in NPL 1. The verification automation system described in the NPL 1 generates a verification script for automatically verifying a system by adopting the concept of Behavior Driven Development (BDD), which verifies whether a system behaves as expected in a given environment. In addition, in the NPL 1, the behaviors expected in the specification are described as test cases to be verified, separately from the concrete implementation of the system. By mapping each instruction statement described in the test case to the concrete implementation, the test case is easy to understand and the instructions for manipulating the system components can be reused.

### CITATION LIST

### Non Patent Literature

NPL 1: Project team for the Network Test System Project conducted at Okinawa Open Laboratory in FY2016, “Network Test System Project FY2016 Results Report”, Okinawa Open Laboratory, Apr. 10, 2017.

### SUMMARY OF INVENTION

### Technical Problem

As mentioned above, as systems become larger and more complex, it is becoming more difficult to exhaustively verify that the system operates properly. This makes it difficult to isolate the cause of the problem when the system does not operate as intended by the designer.

Therefore, it is desirable to be able to separate the parts in the system where a fault may have occurred from the parts in the system where no fault has occurred.

Therefore, it is a principal object of the present invention to provide a fault isolation system, a fault isolation method, and a fault isolation program capable of separating a part in a system where a fault may have occurred from a part in the system where no fault has occurred.

### Solution to Problem

A fault isolation system according to an aspect of the present invention comprises: a configuration information generation unit, when given a set of constituent requirements, wherein the constituent requirement is information indicating a relationship between components, wherein the component is information representing a piece that constitutes a system by a predetermined data structure, generates configuration information representing the system, by repeating operation of replacing the constituent requirement with a set of more concrete constituent requirements according to a replacement rule; an attribute value setting unit that sets an attribute value of the component included in set of constituent requirements after replacement in the configuration information; a verification program generation unit that generates, for each constituent requirement, a verification program for verifying whether parts in the system corresponding to the constituent requirement in the configuration information are normal or not, based on the attribute value; a verification program execution unit that causes the system to execute the verification program; and a fault isolation unit that separates the part in the system where a fault may have occurred from the part where the fault has not occurred, according to whether execution result of the verification program is success or not.

A fault isolation method according to another aspect of the present invention comprises: when given a set of constituent requirements, wherein the constituent requirement is information indicating a relationship between components, wherein the component is information representing a piece that constitutes a system by a predetermined data structure, generating configuration information representing the system, by repeating operation of replacing the constituent requirement with a set of more concrete constituent requirements according to a replacement rule; setting an attribute value of the component included in set of constituent requirements after replacement in the configuration information; generating, for each constituent requirement, a verification program for verifying whether parts in the system corresponding to the constituent requirement in the configuration information are normal or not, based on the attribute value; causing the system to execute the verification program; and separating the part in the system where a fault may have occurred from the part where the fault has not occurred, according to whether execution result of the verification program is success or not.

A fault isolation program according to another aspect of the present invention is a fault isolation program for causing a computer to execute: a configuration information generation process of, when given a set of constituent requirements, wherein the constituent requirement is information indicating a relationship between components, wherein the component is information representing a piece that constitutes a system by a predetermined data structure, generating configuration information representing the system, by repeating operation of replacing the constituent requirement with a set of more concrete constituent requirements according to a replacement rule; an attribute value setting process of setting an attribute value of the component included in set of constituent requirements after replacement in the configuration information; a verification program generation process of generating, for each constituent requirement, a verification program for verifying whether parts in the system corresponding to the constituent requirement in the configuration information are normal or not, based on the attribute value; a verification program execution process of causing the system to execute the verification program; and a fault isolation process of separating the part in the system where a fault may have occurred from the part where the fault has not occurred, according to whether execution result of the verification program is success or not. The present invention may also be a computer-readable recording medium in which the fault isolation program described above is recorded.

### Advantageous Effects of Invention

According to the present invention, it is possible to separate a part in the system where a fault may have occurred from a part in the system where no fault has occurred.

### BRIEF DESCRIPTION OF DRAWINGS

FIG. 1 It depicts a schematic diagram showing a component schematically.

FIG. 2 It depicts a schematic diagram showing a component schematically.

FIG. 3 It depicts a schematic diagram expressing a constituent requirement schematically.

FIG. 4 It depicts a schematic diagram expressing constituent requirements schematically.

FIG. 5 It depicts a schematic diagram showing an example of a replacement rule.

FIG. 6 It depicts a schematic diagram showing an example of a verification item.

FIG. 7 It depicts a schematic diagram showing an example of a verification item.

FIG. 8 It depicts a block diagram showing an example of the configuration of the fault isolation system of the first example embodiment of the present invention.

FIG. 9 It depicts a schematic diagram showing an example of the configuration information.

FIG. 10 It depicts a schematic diagram showing an example of an attribute value constraint condition associated with an input constituent requirement.

FIG. 11 It depicts a flowchart showing an example of the progress of the processing of the first example embodiment of the present invention.

FIG. 12 It depicts a flowchart showing an example of the progress of the processing of the first example embodiment of the present invention.

FIG. 13 It depicts a schematic diagram showing an example of a replacement rule.

FIG. 14 It depicts a schematic diagram showing an example of a replacement rule.

FIG. 15 It depicts a schematic diagram showing an example of a replacement rule.

FIG. 16 It depicts a schematic diagram showing an example of a replacement rule.

FIG. 17 It depicts a schematic diagram showing examples of various verification items stored in the verification item storage unit.

FIG. 18 It depicts a schematic diagram showing some of the verification programs generated for the constituent requirements included in the configuration information illustrated in FIG. 9.

FIG. 19 It depicts a schematic diagram showing an example of the result of the fault isolation by the fault isolation unit.

FIG. 20 It depicts a block diagram showing an example of the configuration of the fault isolation system of the second example embodiment of the present invention.

FIG. 21 It depicts a schematic block diagram showing an example of a computer configuration of the fault isolation system of the present invention, the verification program generation device and the fault isolation device in the second example embodiment,

FIG. 22 It depicts a block diagram showing an overview of the fault isolation system of the present invention.

### DESCRIPTION OF EMBODIMENTS

An example embodiment of the present invention is described below with reference to the drawings.

First, the terminology used in the example embodiments of the present invention will be explained.

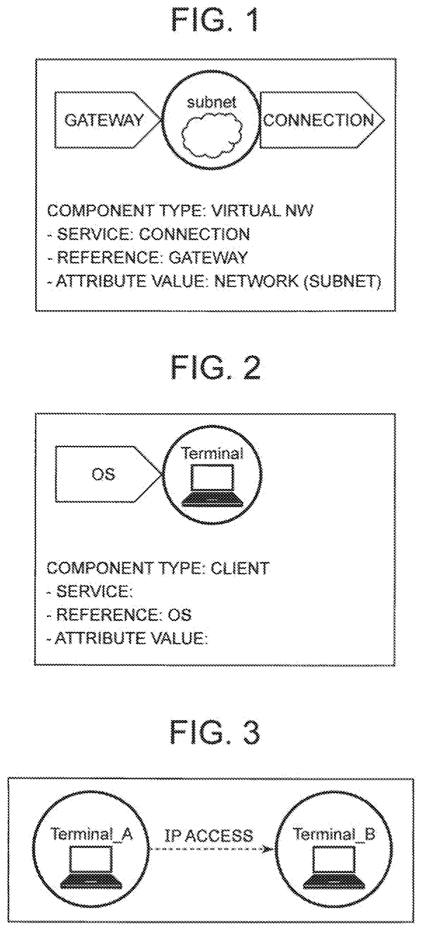

A “component” is information (data) that represents a piece that constitutes a system by a predetermined data structure. Here, the predetermined data structure is specifically a data structure (data set) that can have four elements: “component type”, “service”, “reference” and “attribute value”. In other words, a “component” is a data structure that has four elements: “component type”, “service”, “reference”, and “attribute value”, and is information that represents the piece that constitutes the system. The values of “service”, “reference” and “attribute value” may be “null”. In addition, this data structure is a data structure which can determine a name (e.g., “subnet” in FIG. 1, “terminal” in FIG. 2, etc.).

FIG. 1 and FIG. 2 are schematic diagrams showing a component in a schematically. FIG. 1 illustrates a component representing a “subnet”. FIG. 2 illustrates a component representing a “terminal”. FIG. 2 illustrates a case in which “service” and “attribute value” are “null”.

The “component type” is the type of the component.

A “service” is an element that can be provided by a piece represented by a component.

A “reference” is an element that is necessary for the operation of the piece represented by the component.

An “attribute value” is an attribute value of the piece that is represented by the component. For example, URL (Uniform Resource Locator), IP (Internet Protocol) address, port number, etc. can be described as attribute values, but attribute values are not limited to these.

Also, multiple values may be described as “service”, “reference” and “attribute value”.

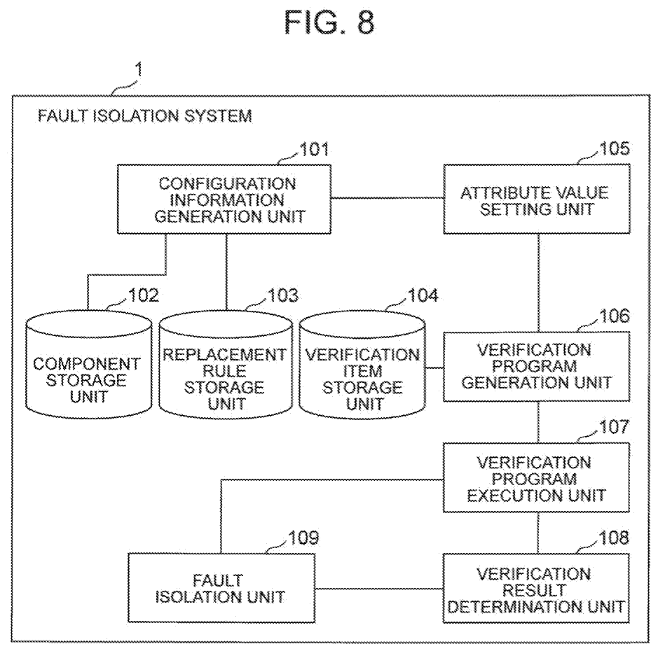

The designer of the system decides for which pieces included in the system to create the components, and the designer creates the components of the decided pieces in advance and stores them in the component storage unit 102 (see FIG. 8) described below.

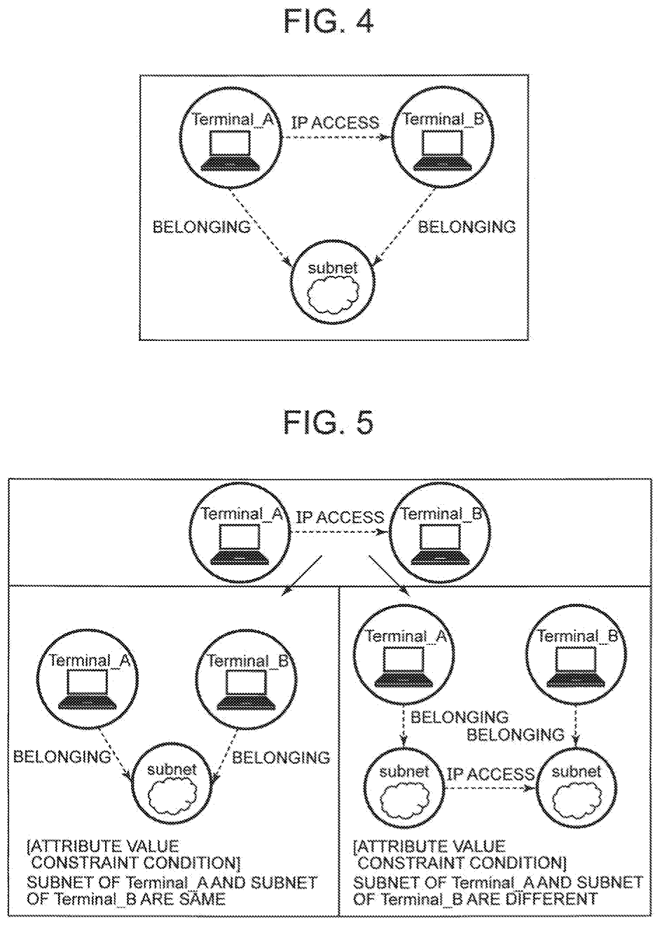

A “constituent requirement” is information (data) that indicates the relationship between components. One constituent requirement includes two components and information that indicates the relationship between the components. In addition, to the information indicating the relationship, flag information indicating whether the relationship is “abstract” or “concrete” is added. In the following description, in order to make the constituent requirements easier to understand, as an example, the components are represented as nodes, and the information indicating the relationship between the components is represented by a graph-style schematic diagram with an edge represented by an arrow. If the relationship between the components is indicated as “abstract” by the above flag information, the relationship is represented by a dashed edge, and if the relationship between the components is indicated as “concrete” by the flag information, the relationship is represented by a solid edge. FIG. 3 and FIG. 4 are schematic diagrams in which the constituent a requirement is schematically represented as described above.

Since one edge is included in one constituent requirement, FIG. 4 shows three constituent requirements. In FIG. 3 and FIG. 4, the text representing the relationship between the components is described in the vicinity of the edges. In addition, in FIG. 3 and FIG. 4, each edge is indicated by a dashed line, which indicates that the relationship between the components is “abstract” in each case.

In addition, each constituent requirement satisfies the condition that the value of the reference of one component is the same as the value of the service of the other component. In the case where the constituent requirements are represented schematically as shown in FIG. 3, etc., the component with the value of the reference is connected to the end without the arrowhead of the edge, and the component with the value of the service is connected to the end with the arrowhead of the edge. Thus, in the example shown in FIG. 3, the value of the reference for “Terminal_A” is the same as the value of the service for “Terminal_B”. As will be described later, a set of constituent requirements is input to the fault isolation system of the example embodiment of the present invention. Here, each of the constituent requirements in that set satisfies the condition that the value of the reference of one component matches the value of the service of the other component.

The “replacement rule” is a rule for replacing a constituent requirement with a set of more concrete constituent requirements, and includes the constituent requirements before the replacement and the set of constituent requirements after the replacement. The number of constituent requirements belonging to the set of constituent requirements after the replacement may be one. Further, the replacement rules include constraint conditions on attribute values of the components included in the set of constituent requirements after the replacement (hereinafter referred to as attribute value constraint condition).

FIG. 5 is a schematic diagram showing an example of a replacement rule. The constituent requirements shown in the upper row of FIG. 5 represent the constituent requirements before replacement. The sets of constituent requirements shown in the lower row of FIG. 5 represent the sets of constituent requirements after the replacement. In the example shown in FIG. 5, a plurality of sets of constituent requirements are shown in the lower row, and each of the plurality of sets of constituent requirements is a candidate for the set of constituent requirements after replacement.

In the example shown in FIG. 5, “the two clients are IP accessible.” is replaced by either a set of constituent requirements indicating that the two clients belong to the same subnet (see the left-hand side of the lower row of FIG. 5), or a set of constituent requirements indicating that the two clients belong to different subnets and are IP accessible between the two subnets (see the right-hand side of the lower row of FIG. 5). Each candidate of the set of constituent requirements after replacement has an attribute value constraint condition associated with it in advance.

There may still be “abstract relationships (dashed edges)” in the set of constituent requirements after replacement.

Each of the constituent requirements included in the replacement rules also satisfies the condition that the value of the reference of one component is the same as the value of the service of the other component. The designer of the system creates a plurality of replacement rules in advance to satisfy this condition, and stores the plurality of replacement rules in the replacement rule storage unit 103 (see FIG. 8) described below.

In addition, although FIG. 5 illustrates a replacement rule that includes two candidates for the set of constituent requirements after replacement, the replacement rule may specify one set of constituent requirements after replacement.

A “verification item” is information describing an instruction to be executed by the system using a variable. The verification items are created in advance by the designer of the system in association with the constituent requirements, and are stored in the verification item storage unit 104 (see FIG. 8) described below.

By assigning the attribute values of the components to the variables described in the verification items, a verification program is generated to verify whether the parts in the system corresponding to the constituent requirements are normal or not.

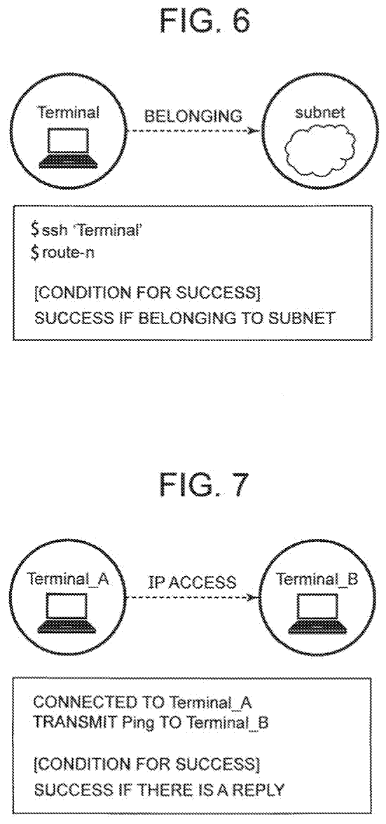

The verification items may be described in the descriptive form of the actual program. Alternatively, the verification items may be described in a descriptive format based on other verification automation technologies such as BDD. FIG. 6 shows an example of verification item described in the description format of an actual program. FIG. 7 shows an example of verification item described in a descriptive form based on other verification automation techniques such as BDD. In both FIG. 6 and FIG. 7, the constituent requirement associated with the verification item is also shown in the figures. In the example shown in FIG. 6, the part corresponding to a variable is indicated by a quotation mark.

The verification items also describe the conditions under which the execution result of the verification program generated based on the verification items is a “success”. If this condition is satisfied, the execution result of the verification program is a success; otherwise, the execution result of the verification program is not a success. In the example shown in FIG. 6, the condition “Success if belonging to the subnet” is described as a condition that the execution result of the verification program generated based on the verification item is a success. In addition, in the example shown in FIG. 7, the condition “Success if there is a reply” is described as a condition that the execution result of the verification program generated based on the verification item is success.

### Example Embodiments 1

FIG. 8 is a block diagram showing an example of the configuration of a fault isolation system of the first example embodiment of the present invention. The fault isolation system 1 of the first example embodiment comprises a configuration information generation unit 101, a component storage unit 102, a replacement rule storage unit 103, a verification item storage unit 104, an attribute value setting unit 105, a verification program generation unit 106, a verification program execution unit 107, a verification result determination unit 108, and a fault isolation unit 109.

The component storage unit 102 is a storage device that stores a plurality of components of the system (see, for example, FIGS. 1 and 2) that have been created in advance by the designer of the system.

The replacement rule storage unit 103 is a storage device that stores a plurality of replacement rules (see, for example, FIG. 5) that have been created in advance by the designer of the system.

A set of constituent requirements representing the system is input to the configuration information generation unit 101. The number of constituent requirements included in this set of constituent requirements may be one. Also, the set of inputted constituent requirements includes a relation that is indicated as “abstract” by flag information. The set of inputted constituent requirements may include not only the relationship indicated as “abstract” by the flag information but also the relationship indicated as “concrete” by the flag information.

Also, in the set of constituent requirements, information specifying a component corresponding to a node may be specified, and the configuration information generation unit 101 may determine the set of constituent requirements by reading a component corresponding to the specification from the component storage unit 102 when the set of constituent requirements is input.

When a set of constituent requirements is input, the configuration information generation unit 101 generates configuration information, which is information representing the system, by repeating the operation of replacing the constituent requirements with a set of more concrete constituent requirements according to the replacement rules. The number of constituent requirements included in the set of constituent requirements after replacement may be one.

More specifically, the configuration information generation unit 101 reads, from the replacement rule storage unit 103, a replacement rule that defines the constituent requirement as a constituent requirement before replacement, when the constituent requirement includes a relation that is indicated as “abstract”. Then, the configuration information generation unit 101 replaces the constituent requirement with the set of constituent requirements after replacement specified in the replacement rules. For example, if the constituent requirement illustrated in FIG. 3 exists, the configuration information generation unit 101 replaces the constituent requirement with the set of constituent requirements shown on the left side of the lower row of FIG. 5 (a set of constituent requirements indicating that two clients belong to the same subnet) or with the set of constituent requirements shown on the right side of the lower row of FIG. 5 (a set of constituent requirements indicating that the two clients belong to different subnets and that IP access is possible between the two subnets) according to the replacement rules illustrated in FIG. 5. In other words, the replacement operation can be regarded as rewriting the abstract constituent requirement represented graphically in this example embodiment into constituent requirements that are at least more concrete than the abstract constituent requirement, referring to the replacement rules (i.e., rewriting rules).

Here, as illustrated in FIG. 5, if there is a plurality of candidates for the set of constituent requirements after replacement, one candidate can be selected from the plurality of candidates in a predetermined manner. For example, the configuration information generation unit 101 may calculate a cost for each candidate of the set of constituent requirements to be replaced using a cost function (e.g., a function that derives a price of a piece represented by the component), and select the candidate with the lowest cost as the set of constituent requirements to be replaced. For example, the configuration information generation unit 101 may select, among each candidate of the set of constituent requirements after replacement, the candidate that minimizes the number of included nodes (components) as the set of constituent requirements after replacement. Also, the configuration information generation unit 101 may randomly select a set of the constituent requirements after replacement from among a plurality of candidates.

If a constituent requirement including a relation indicated as “abstract” exists in the set of constituent requirements after the replacement, the configuration information generation unit 101 repeats the operation of replacing the constituent requirement with the set of constituent requirements in the same manner. The configuration information generation unit 101 repeats this operation until there are no more constituent requirements that include the relation indicated as “abstract”. In other words, the configuration information generation unit 101 repeats the above replacement operation until the relations contained in all the constituent requirements correspond to “concrete”.

In addition, the configuration information generation unit 101 stores the entire process of the replacement operation of the constituent requirements that include the relation indicated as “abstract”. Specifically, the configuration information generation unit 101 stores the combination of the constituent requirement before the replacement and the set of constituent requirements after the replacement, when the constituent requirement including the relation indicated as “abstract” are replaced with the set of constituent requirements according to the replacement rules. For example, when the configuration information generation unit 101 replaces the constituent requirement illustrated in FIG. 3 with the set of constituent requirements shown in the lower left-hand side of FIG. 5, the configuration information generation unit 101 stores the combination of the constituent requirement shown in FIG. 3 and the set of constituent requirements shown in the lower left-hand side of FIG. 5. The configuration information generation unit 101 stores such a combination for each replacement. As a result, the configuration information generation unit 101 can store the entire process of the replacement operation of the constituent requirements.

The combination of the constituent requirement before replacement and the set of constituent requirements after replacement can also be used to identify the replacement rule used during replacement.

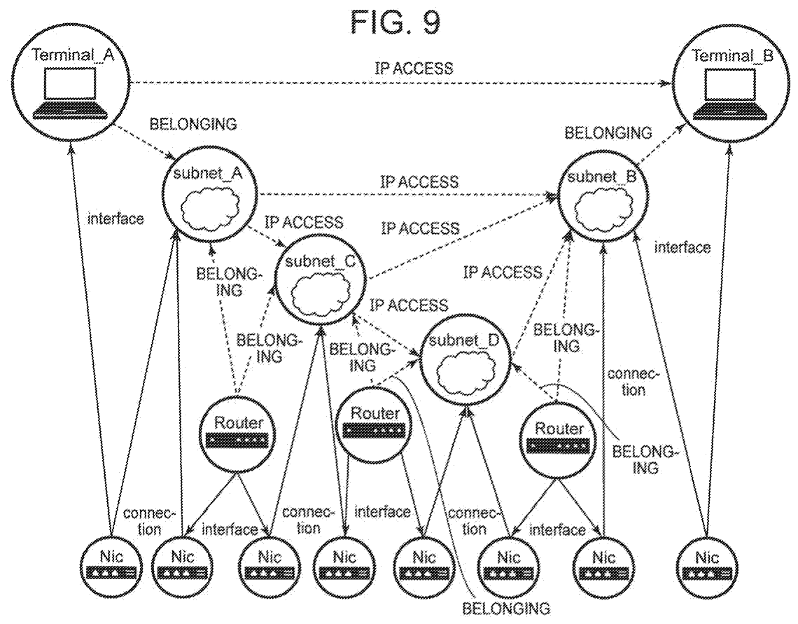

As described above, the set of combinations of the constituent requirement before replacement and the set of constituent requirements after replacement can be said to be information that more concretely represents the system represented by the set of constituent requirements input to the configuration information generation unit 101. Hereafter, the set of combinations of the constituent requirement before replacement and the set of constituent requirements after replacement will be referred to as configuration information. A schematic diagram of the configuration information that can be generated when the set of constituent requirements illustrated in FIG. 3 (one constituent requirement in the example shown in FIG. 3) is input is shown in FIG. 9.

The attribute values of the components included in the set of constituent requirements after replacement by the configuration information generation unit 101 are “null” and are not defined. The operation of setting the attribute values of the components included in the set of constituent requirements is performed by the attribute value setting unit 105 described below.

The attribute value setting unit 105 sets the attribute values of the components included in the set of constituent requirements after replacement by the configuration information generation unit 101. At this time, the attribute value setting unit 105 sets the attribute values of the components included in the set of the constituent requirements after replacement using the attribute value constraint conditions associated with the replacement rules used to derive the set of the constituent requirements after replacement. That is, the attribute value setting unit 105 sets the attribute values of the components included in the set of the constituent requirements after replacement to satisfy the attribute value constraint conditions associated with the replacement rules used to derive the set of the constituent requirements after replacement. At this time, the attribute value setting unit 105 may set the attribute values of the components included in the set of the constituent requirements after the replacement based on the attribute values of the components included in the constituent requirement before the replacement and the attribute value constraint conditions associated with the replacement rules used to derive the set of the constituent requirements after the replacement. The attribute value setting unit 105 may also set attribute values with respect to the relationships between the components included in the set of constituent requirements after replacement.

For example, if the replacement to the set of constituent requirements shown in the lower left-hand side of FIG. 5 is performed based on the replacement rule illustrated in FIG. 5, the attribute value setting unit 105 determines the attribute value of “subnet” included in the set of constituent requirements after the replacement so as to satisfy the attribute value constraint condition (see the lower left-hand side of FIG. 5) that “the subnet of Terminal_A and the subnet of Terminal_B are the same.

As described above, the configuration information generation unit 101 stores the combination of the constituent requirement before the replacement and the set of constituent requirements after the replacement. Then, from the combination of the constituent requirement before replacement and the set of constituent requirements after replacement, the replacement rule used at the time of replacement can be identified. Accordingly, the attribute value setting unit 105 can identify the attribute value constraint conditions to be used when setting the attribute values of the components included in the set of constituent requirements after the replacement based on the information stored by the configuration information generation unit 101.

The attribute value constraint condition may be associated with a constituent requirement that is input to the configuration information generation unit 101. Then, the attribute value setting unit 105 may set an attribute value of the component included in the constituent requirement, whose value is undetermined, to satisfy the attribute value constraint condition.

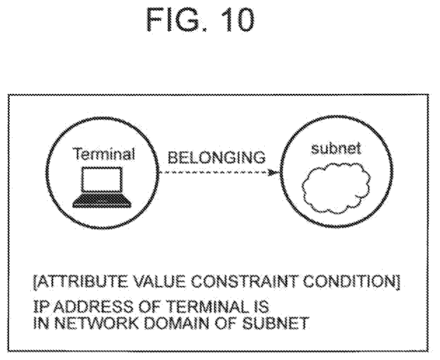

An example of an attribute value constraint condition associated with an input constituent requirement is shown in FIG. 10. In the constituent requirement illustrated in FIG. 10, it is assumed that the attribute value (IP address) of “subnet” is given as “192.168.1.0/24”. Also, suppose that the attribute value of “Terminal” shown in FIG. 10 is not defined. In this case, the attribute value setting unit 105 sets the attribute value of “Terminal” shown in FIG. 10 a value of “192.168.1.1” to “192.168.1.254”, based on the attribute value (IP address) “192.168.1.0/24” of “subnet” and the attribute value constraint conditions shown in FIG. 10.

When there are a plurality of attribute values satisfying the attribute value constraint conditions, the method of selecting one attribute value from among them is not particularly limited. For example, the attribute value setting unit 105 may select an attribute value from the plurality of attribute values that satisfy the attribute value constraint condition in ascending order. Also, for example, the attribute value setting unit 105 may randomly select an attribute value from a plurality of attribute values that satisfy the attribute value constraint condition.

Here, it is assumed that the result of setting attribute values to the components included in the configuration information (e.g., see FIG. 9) corresponds to the actual system. The actual system may be constructed based on the results of setting attribute values to the components included in the configuration information. Alternatively, the constituent requirements to be input, the components to be stored in the component storage unit 102, and the replacement rules to be stored in the replacement rule storage unit 103 can be determined in advance so that the result of setting the attribute values to the components included in the configuration information corresponds to the actual system.

The verification program generation unit 106 generates a verification program for each constituent requirement based on each set attribute value. As already described, the verification program is a program for verifying whether the part in the system corresponding to the constituent requirement is normal or not.

The verification item storage unit 104 is a storage device that stores verification items according to types of constituent requirements for each of the various types of constituent requirements. As already explained, a “verification item” is information describing an instruction to be executed by the system using a variable.

More specifically, the verification program generation unit 106 generates, for each constituent requirement included in the configuration information, a verification program associated with the constituent requirement by assigning an attribute value of a component included in the constituent requirement to a variable described in a verification item corresponding to the type of the constituent requirement.

For example, if the configuration information represented as illustrated in FIG. 9 is obtained, the individual edges are included in the individual constituent requirement. The verification program generation unit 106 generates a verification program for each of those constituent requirements. As a result, for example, for each individual constituent requirement corresponding to an individual edge illustrated in FIG. 9, such as “a constituent requirement indicating that the relationship between Terminal_A and Terminal_B is IP access” and “a constituent requirement indicating that the relationship between Terminal_A and subnet_A is belonging,” a verification program is generated.

The verification program execution unit 107 causes the actual system corresponding to the result of setting attribute values to the components included in the configuration information (see, for example, FIG. 9) to execute the verification program.

The verification result determination unit 108 determines whether the execution result of the verification program by the system is a success or not by comparing the execution result of the verification program by the system with the condition for the execution result to be a success (hereinafter simply referred to as the condition for success) associated with the verification items used to generate the verification program. The verification result determination unit 108 determines that the execution result of the verification program is a success if the execution result of the verification program satisfies the “condition for success” for the verification program. If the execution result of the verification program does not satisfy the “condition for success” for the verification program, the verification result determination unit 108 determines that the execution result of the verification program is not a success.

The verification result determination unit 108 performs the above determination operation every time the verification program execution unit 107 causes the system to execute the verification program.

Each time the verification program execution unit 107 causes the system to execute the verification program, the fault isolation unit 109 separates the part in the system where the fault may have occurred from the part in the system where the fault has not occurred, according to the result of the verification result determination unit 108 determining whether the execution result of the verification program is success or not.

For example, if the execution result of the verification program is a success, the fault isolation unit 109 determines that the part in the system corresponding to the constituent requirement associated with the verification program is a part where no fault has occurred. If the execution result of the verification program is not a success, the fault isolation unit 109 determines that the part in the system corresponding to the constituent requirement associated with the verification program is a part where a fault may have occurred.

Also, the verification program execution unit 107 may, for example, cause the system to execute a verification program associated with a constituent requirement belonging to the set of constituent requirements that was first input to the configuration information generation unit 101, and if the result of execution of the verification program is not a success, the verification program execution unit 107 causes the system to execute the verification program associated with constituent requirement for each constituent requirement that belongs to the set of constituent requirement replaced from the constituent requirement. The following is an example of the case where the verification program execution unit 107 causes the system to execute the verification program as described above. In this case, a constituent requirement may arise for which the associated verification program is not executed.

As another example, the verification program execution unit 107 may cause the system to execute the verification program associated with the constituent requirement for each individual constituent requirement included in the configuration information. In this case, the verification program is exhaustively executed for each constituent requirement included in the configuration information.

In the present example embodiment, the configuration information generation unit 101, the attribute value setting unit 105, the verification program generation unit 106, the verification program execution unit 107, the verification result determination unit 108, and the fault isolation unit 109 are realized, for example, by a CPU (Central Processing Unit) of a computer that operates according to the fault isolation program. In this case, the CPU reads the fault isolation program from a program recording medium such as a program storage device of the computer, and according to the fault isolation program, the CPU operates as the configuration information generation unit 101, the attribute value setting unit 105, the verification program generation unit 106, the verification program execution unit 107, the verification result determination unit 108, and the fault isolation unit 109.

Alternatively, the configuration information generation unit 101, the attribute value setting unit 105, the verification program generation unit 106, the verification program execution unit 107, the verification result determination unit 108, and the fault isolation unit 109 may each be realized by individual hardware that is provided in a communicable manner.

The component storage unit 102, the replacement rule storage unit 103, and the verification item storage unit 104 are realized, for example, by a storage device provided in a computer.

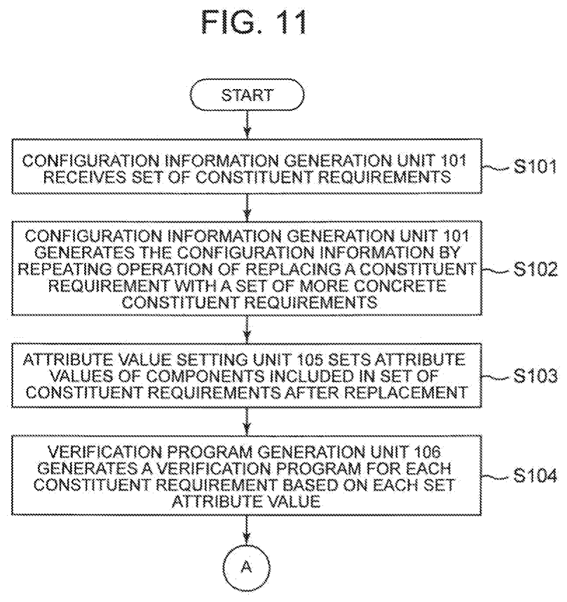

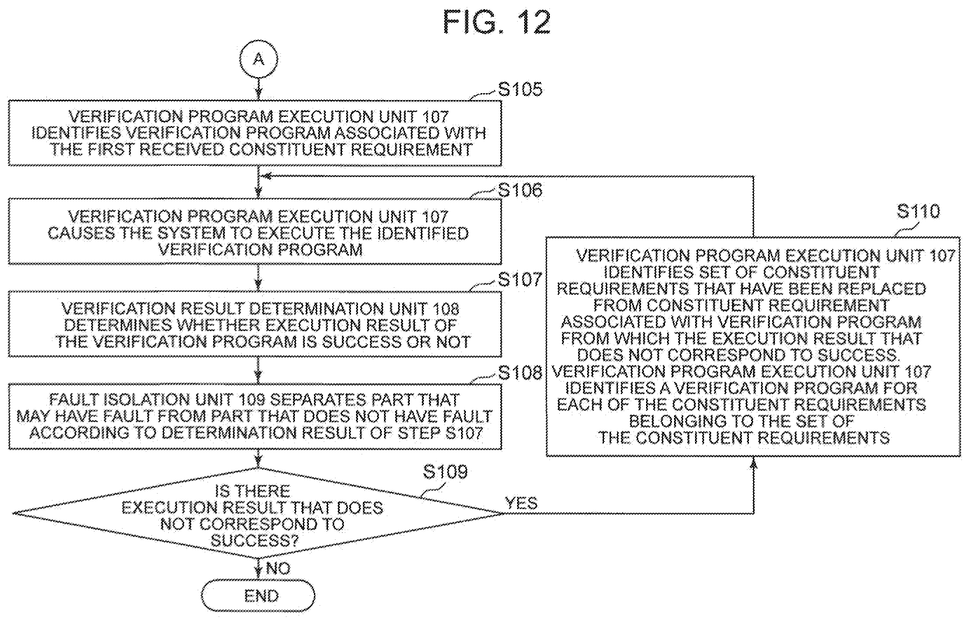

Next, the progress of the processing that realizes the operation of the fault isolation system of this example embodiment described above will be described. FIG. 11 and FIG. 12 are flowcharts showing examples of the progress of the processing of the first example embodiment of the present invention. Detailed explanations are omitted for the matters already described.

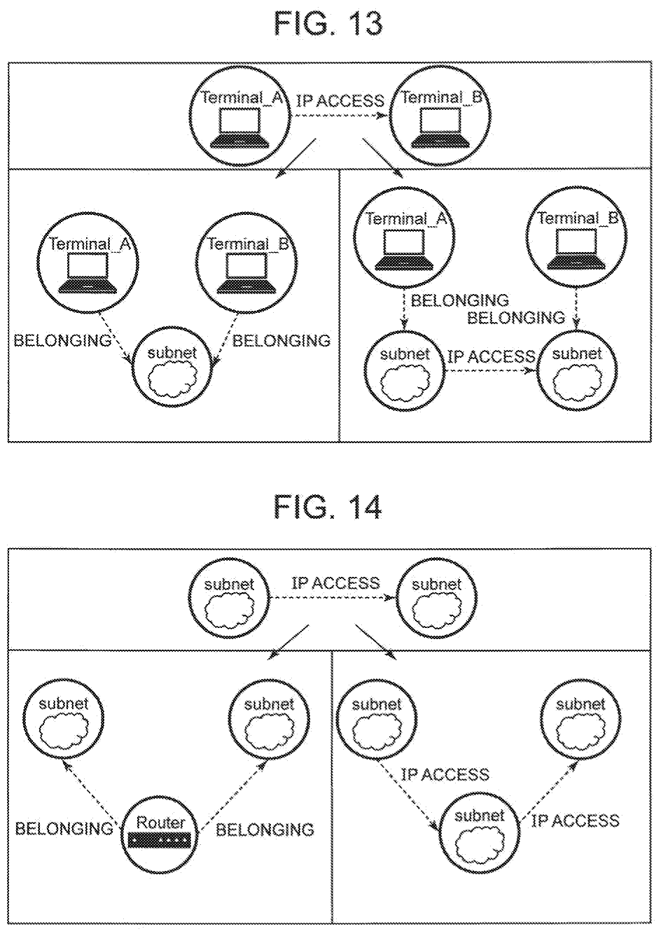

In this example, it is assumed that the replacement rule storage unit 103 stores, for example, the replacement rules illustrated in FIGS. 13 to 16. However, in the examples shown in FIGS. 13 to 16, the attribute value constraint conditions included in the replacement rules are omitted.

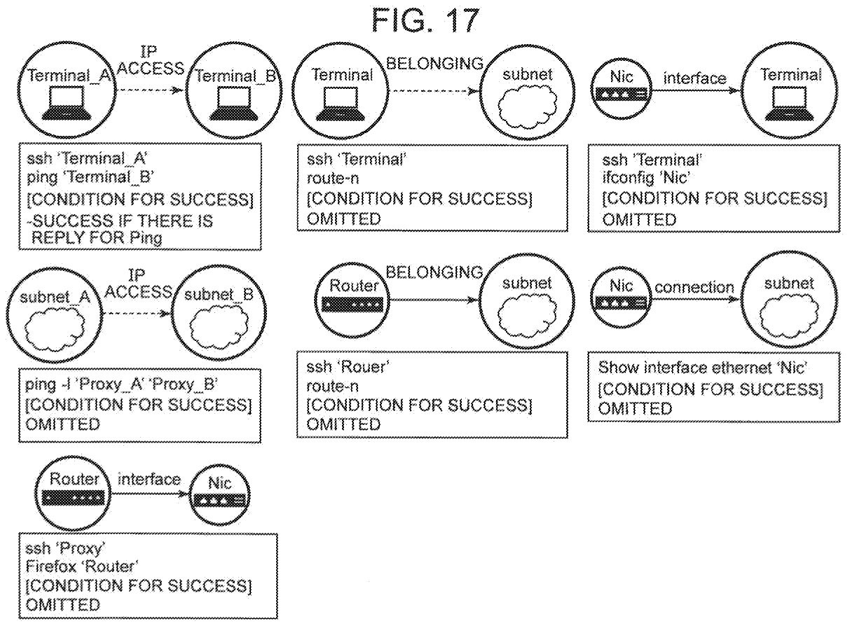

In this example, it is assumed that the verification item storage unit 104 stores the verification items shown in FIG. 17, for example. In the example shown in FIG. 17, with the exception of some verification items, the illustration of “condition for success” is omitted.

First, the configuration information generation unit 101 receives an input of a set of constituent requirements representing the system (step S101). Here, it is taken as an example that the configuration information generation unit 101 receives the set of constituent requirements from an external device via a communication interface (not shown in FIG. 8) of the fault isolation system 1.

Here, a case in which the configuration information generation unit 101 receives, as a set of constituent requirements, the set of constituent requirements shown in FIG. 3 is used as an example. The set of constituent requirements shown in FIG. 3 includes one constituent requirement.

Next to step S101, the configuration information generation unit 101 generates the configuration information by repeating the operation (process) of replacing a constituent requirement including a relationship that fall under the “abstract” (shown schematically with dashed edges in the drawing) with a set of more concrete constituent requirements (Step S102).

In this example, the initially inputted “constituent requirement indicating that the relationship between Terminal_A and Terminal_B is IP access (see FIG. 3)” is replaced with a set of constituent requirements indicating that “Terminal_A and Terminal_B have a relationship of belonging with the same subnet (see the left-hand side of the lower row of FIG. 13), or with a set of constituent requirements indicating that “Terminal_A and Terminal_B have a relationship of belonging with different subnets, and the relationship between the subnets is IP access” (see the right-hand side of the lower row of FIG. 13). Here, it is assumed that the configuration information generation unit 101 replaces the constituent requirements shown in FIG. 3 with the latter.

Similarly, the constituent requirement indicating “the relationship of two subnets (hereinafter referred to as subnet_A and subnet_B) is IP access”, in the set of constituent requirements indicating that “Terminal_A and Terminal_B have a relationship of belonging with different subnets, and the relationship between the subnets is IP access” (see the right-hand side of the lower row of FIG. 13), is replaced, according to replacement rule shown in FIG. 14, with the set of constituent requirements indicating that “one router and each of subnet_A and subnet_B have a relationship of belonging” (see the lower left-hand side of FIG. 14), or with the set of constituent requirements indicating that “the relationship between one subnet_A and one subnet is IP access, and the relationship between the one subnet and subnet_B is IP access” (see the lower right-hand side of FIG. 14). Here, based on the replacement rule illustrated in FIG. 14, it is assumed that the configuration information generation unit 101 replaces the constituent requirement “the relationship between the two subnets (subnet_A, subnet_B) is IP access” with the latter, and at this time, a new subnet_C is generated.

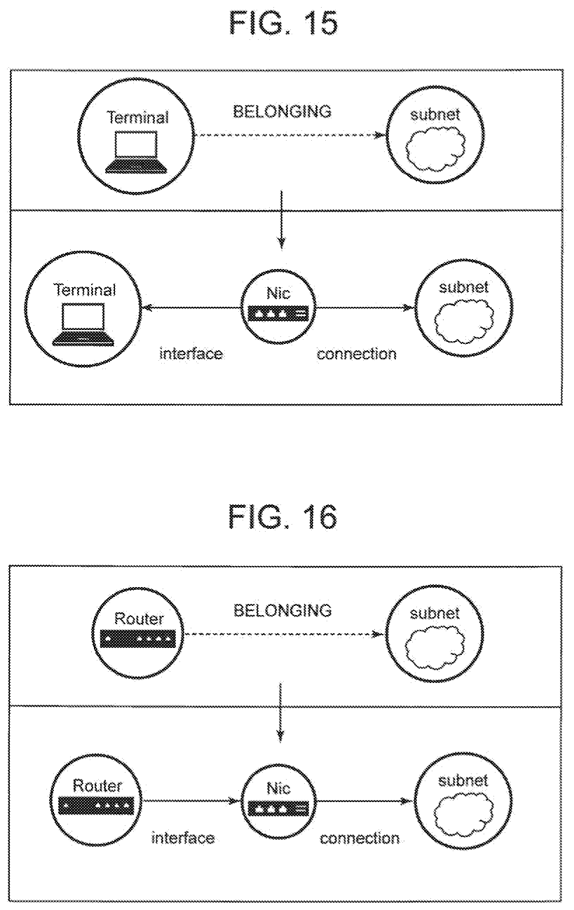

In addition, the constituent requirement indicating that “Terminal_A and subnet_A have the relationship of belonging” included in the set of constituent requirements shown in the lower right-hand side of FIG. 13 is replaced, according to replacement rule shown in FIG. 15, with the set of constituent requirements indicating that “Nic (Network Interface Card) and Terminal_A have the relationship of interface, and Nic and subnet_A have the relationship of connection” (see the lower row of FIG. 15). In this set of constituent requirements, the relationship between Nic and Terminal_A and the relationship between Nic and subnet_A are both concrete. Therefore, the replacement does not occur for each of the constituent requirements belonging to the set of constituent requirements shown in the lower row of FIG. 15.

The constituent requirements indicating that “Terminal_B and subnet_B have the relationship of belonging” in the set of constituent requirements shown on the right side of the lower row of FIG. 13 are similarly replaced.

In addition, the constituent requirement “the relationship between subnet_A and subnet_C is IP access” can be replaced, according to replacement rule shown in FIG. 14, with a set of constituent requirements indicating that “one router and subnet_A, the one router and subnet_C each have a relationship of belonging” (see the left-hand side of the lower row of FIG. 14), or replaced with a set of constituent requirements indicating that “the relationship between subnet_A and one subnet is IP access, and the relationship between the one subnet and subnet_C is IP access” (see the right-hand side of the lower row of FIG. 14). Here, it is assumed that the configuration information generation unit 101 replaces the constituent requirement “the relationship between the subnet_A and the subnet_C is IP access” with the former and generates a new Router.

In addition, the constituent requirement indicating that “Router and subnet_A have the relationship of belonging” included in the set of constituent requirements shown in the lower left-hand side of FIG. 14 is replaced, according to replacement rule shown in FIG. 16, with the set of constituent requirements indicating that “Router and Nic have the relationship of interface and Nic and subnet_A have the relationship of connection” (see the lower row of FIG. 16). In this set of constituent requirements, the relationship between Router and Nic and the relationship between Nic and subnet_A are both concrete. Therefore, no replacement occurs for the respective constituent requirements belonging to the set of constituent requirements shown in the lower row of FIG. 16.

Similarly, the constituent requirement indicating that “Router and subnet_B have the relationship of belonging” in the set of constituent requirements shown in the lower left-hand side of FIG. 14 are replaced.

In this manner, the configuration information generation unit 101 repeats the operation (processing) of replacing the constituent requirement that include relations that fall under “abstract” with a set of more concrete constituent requirements. In addition, the configuration information generation unit 101 repeats the above replacement until the relations contained in all the constituent requirements fall under the “concrete”.

As a result, for example, the configuration information represented as illustrated in FIG. 9 is obtained.

In step S102, the configuration information generation unit 101 stores, for each replacement, a combination of the constituent requirement before the replacement and the set of constituent requirements after the replacement. At this time, the configuration information generation unit 101 may store, along with this combination, the replacement rule used for the replacement and the attribute value constraint condition associated with the replacement rule.

Next to step S102, the attribute value setting unit 105 sets the attribute values of the components included in the set of constituent requirements after the replacement by the configuration information generation unit 101 (step S103). The attribute value setting unit 105 sets the attribute values of the components included in the set of constituent requirements after the replacement using the attribute value constraint conditions associated with the replacement rules used to derive the set of constituent requirements after the replacement. The attribute value setting unit 105 may set the attribute values with respect to the relationships between the components included in the set of constituent requirements after the replacement.

Next to step S103, the verification program generation unit 106 generates a verification program for each constituent requirement based on each set attribute value (step S104). In step S104, for each constituent requirement included in the configuration information, the verification program generation unit 106 can generate a verification program associated with the constituent requirement by assigning an attribute value of a component included in the constituent requirement to a variable described in a verification item according to a type of the constituent requirement. In addition, the verification program generation unit 106 can read the verification item according to the type of the constituent requirement from the verification item storage unit 104.

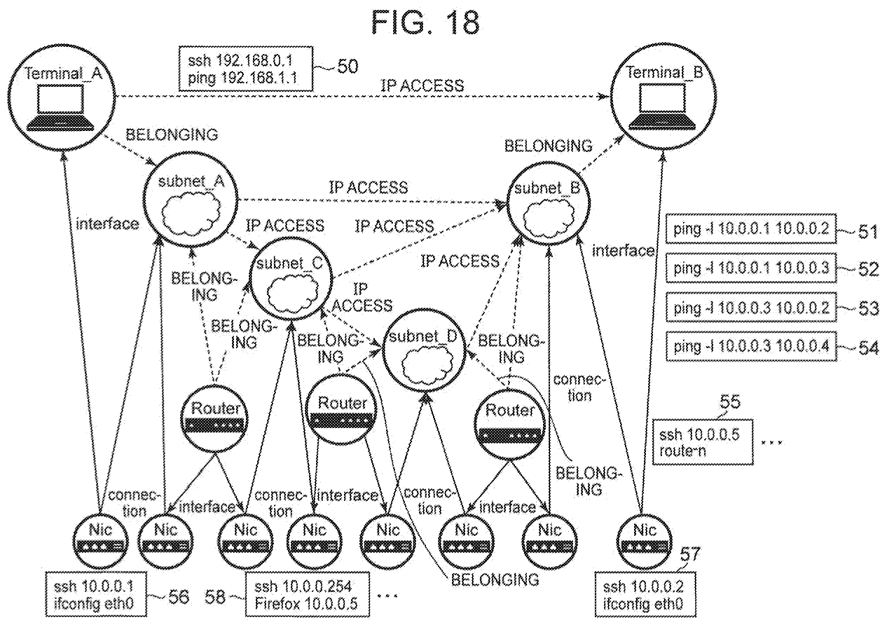

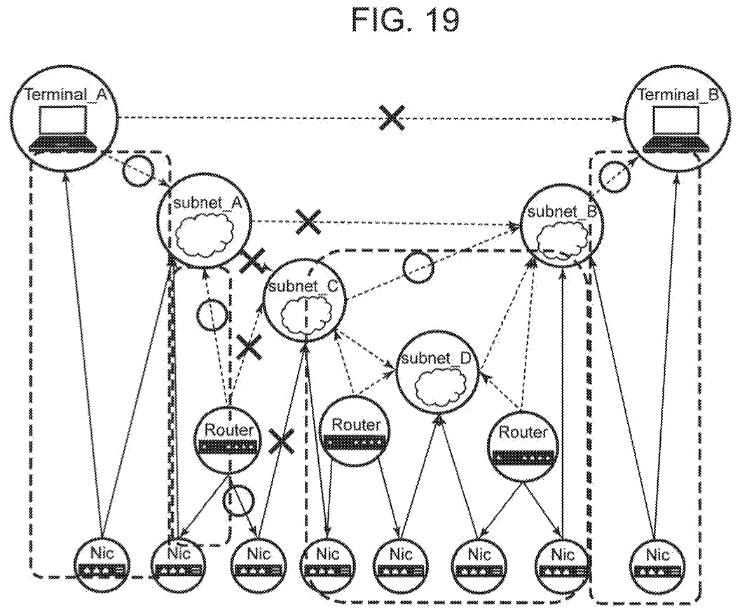

FIG. 18 is a schematic diagram showing some of the verification programs generated for the constituent requirements included in the configuration information illustrated in FIG. 9.

The verification program 50 is a verification program associated with a constituent requirement that indicates that the relationship between Terminal_A and Terminal_B is IP access.

The verification programs 51-54 are verification programs associated with constituent requirements indicating that the relationship between two subnets is IP access, respectively.

The verification program 55 is a verification program associated with a constituent requirement indicating that a relationship between a Router and a subnet is belonging.

The verification programs 56 and 57 are verification programs associated with the constituent requirement that the relationship between Nic and Terminal is interface, respectively.

The verification program 58 is a verification program associated with the constituent requirement that the relationship between the Router and the Nic is interface.

The verification program generation unit 106 generates a verification program for each constituent requirement, and FIG. 18 illustrates some of the generated verification programs.

In this example, the verification program execution unit 107 causes the system to execute a verification program associated with a constituent requirement belonging to the set of constituent requirements that was first input to the configuration information generation unit 101, and if the result of the execution of the verification program is not success, the verification program execution unit 107 causes the system to execute verification program associated with constituent requirement for each constituent requirement included in the set of constituent requirements replaced from the constituent requirement.

In this case, next to step S104, the verification program execution unit 107 identifies the verification program associated with the first received constituent requirement (step S105. See FIG. 12). In this example, in step S105, the verification program execution unit 107 identifies the verification program 50 shown in FIG. 18.

Next to step S105, the verification program execution unit 107 causes the system to execute the identified verification program (step S106).

Next, the verification result determination unit 108 determines whether the execution result of the verification program is a success or not (step S107). The verification result determination unit 108 determines that the execution result of the verification program is a success if the execution result of the verification program satisfies the “condition for success” relating the verification program. If the execution result of the verification program does not satisfy the “condition for success” relating the verification program, the verification result determination unit 108 determines that the execution result is not a success.

Next, the fault isolation unit 109 separates a part that may have a fault from a part that does not have a fault according to the determination result of step S107 (step S108). If the determination result is success, the fault isolation unit 109 determines that the fault has not occurred with respect to the part in the system corresponding to the constituent requirement associated with the verification program executed in step S106. If the determination result is not success, the fault isolation unit 109 determines that the fault may have occurred with respect to the part in the system corresponding to the constituent requirement associated with the verification program executed in step S106.

Next, the fault isolation unit 109 determines whether or not there is an execution result that does not correspond to success among the execution results obtained in the step S106 (step S109). If there are no execution results that do not correspond to successes among the execution results obtained in step S106 (No in step S109), then the process is terminated with respect to the most recent step S106 and thereafter.

If there are execution results obtained in step S106 that do not correspond to successes (Yes in step S109), then the verification program execution unit 107 identifies a set of constituent requirements that have been replaced from the constituent requirement associated with the verification program from which the execution result that does not correspond to success. Then, the verification program execution unit 107 identifies a verification program for each of the constituent requirements belonging to the set of the constituent requirements (step S110). If there are execution results that correspond to successes as well as execution results that do not correspond to successes, the execution results that correspond to successes may be ignored in step S110.

After step S110, the process from step S106 onward is repeated. If multiple verification programs are identified in step S105 or step S110, steps S106 to S108 are executed for each of those verification programs.

The following are specific examples from step S105 onwards. It is assumed that the verification program 50 (see FIG. 18) associated with the first input constituent requirement (the constituent requirement that the relationship between Terminal_A and Terminal_B is IP access. See FIG. 3.) is identified in step S105. And it is assumed that the result of executing the verification program 50 in the system is not success. In this case, the fault isolation unit 109 determines that the fault may have occurred with respect to the part corresponding to the first input constituent requirement (the constituent requirement that the relationship between Terminal_A and Terminal_B is IP access). In the configuration information shown schematically in FIG. 9, etc., a cross mark is added to the edge associated with the constituent requirement to represent a location where a fault may occur, and a circle mark is added to the edge associated with the constituent requirement to represent a location where no fault has occurred (see FIG. 19).

In the above case, the process moves from step S109 to step S110. Then, the set of constituent requirements replaced from the constituent requirement (see FIG. 3) that the relationship between Terminal_A and Terminal_B is IP access is identified. In this example, the set of constituent requirements indicating that “the relationship between Terminal_A and subnet_A is belonging, the relationship between subnet_A and subnet_B is IP access, and the relationship between Terminal_B and subnet_B is belonging” is identified. This set of constituent requirements includes the constituent requirement indicating that the relationship between Terminal_A and subnet_A is belonging, the constituent requirement indicating that the relationship between subnet_A and subnet_B is IP access, and the constituent requirement indicating that the relationship between Terminal_B and subnet_B is belonging. For each of these three constituent requirements, the verification program execution unit 107 identifies a verification program associated with the constituent requirement. In other words, here, three verification programs are identified.

The verification program execution unit 107, the verification result determination unit 108 and the fault isolation unit 109 execute steps S106 to S108 for each of these verification programs.

Here, it is assumed that execution result is success with respect to the verification program associated with the constituent requirement indicating that the relationship between Terminal_A and subnet_A is belonging and the verification program associated with the constituent requirement indicating that the relationship between Terminal_B and subnet_B is belonging. In this case, the fault isolation unit 109 determines that the fault has not occurred with respect to the respective parts corresponding to these two constituent requirements.

Further, it is assumed that no execution result corresponding to success was obtained for the verification program associated with the constituent requirement indicating that the relationship between subnet_A and subnet_B is IP access. In this case, the fault isolation unit 109 determines that the part corresponding to this constituent requirement is a part where a fault may have occurred.

Then, since there are execution results among the execution results of the three verification programs that do not correspond to success (Yes in step S109), the process is moved to step S110. Here, the verification program execution unit 107 identifies a set of constituent requirements that have been replaced from the constituent requirement indicating that the relationship between the subnet_A and the subnet_B is an IP access. In this example, the set of constituent requirements indicating that “the relationship between subnet_A and subnet_C is IP access and that the relationship between subnet_C and subnet_B is IP access” is identified. This set of constituent requirements includes a constituent requirement indicating that the relationship between subnet_A and subnet_C is IP access and a constituent requirement indicating that the relationship between subnet_C and subnet_B is IP access. The verification program execution unit 107 identifies, for each of these two constituent requirements, a verification program associated with the constituent requirement.

The verification program execution unit 107, the verification result determination unit 108 and the fault isolation unit 109 execute steps S106 to S108 for each of these verification programs.

If there is no longer a transition to step S110, then the process ends.

FIG. 19 is a schematic diagram showing an example of a result by the fault isolation unit 109 obtained in the manner described in the above example. As already described, a cross mark is added to an edge associated with a constituent requirement to represent a location where a fault may have occurred, and a circle mark is added to an edge associated with a constituent requirement to represent a location where no fault has occurred.

In the system represented by the configuration information generated by the configuration information generation unit 101, if the execution result of the verification program associated with a more concrete constituent requirement does not satisfy the condition of success, the execution result of the verification program associated with the constituent requirement from which the constituent requirement is derived (in other words, the constituent requirement before replacement) also does not satisfy the condition of success. For example, in the example shown in FIG. 19, if the verification program associated with the constituent requirement indicating that the relationship between subnet_A and subnet_B is IP access does not produce an execution result corresponding to success, the verification program associated with the constituent requirement indicating that the relationship between terminal_A and terminal_B is IP access does not produce an execution result corresponding to success. In other words, if IP access is not possible between subnet_A and subnet_B, IP access is also not possible between Terminal_A and Terminal_B.

If the execution result of the verification program associated with a more abstract constituent requirement satisfies the condition for success, then the execution result of the verification program associated with the individual constituent requirement obtained by replacement from the constituent requirement also satisfies the condition for success. For example, in the example shown in FIG. 19, the execution result of the verification program associated with the constituent requirement indicating that the relationship between terminal_A and subnet_A is belonging satisfies the condition of success. Therefore, the execution results of the verification program associated with the individual constituent requirement obtained by replacement from this constituent requirement also satisfy the condition for success. In the aforementioned process, execution is omitted for the verification programs whose execution results are known to satisfy condition for success. In addition, in the example shown in FIG. 19, the constituent requirements associated with the verification program whose execution result is known to satisfy condition for success are illustrated by enclosing them in a dashed line with a rounded rectangle.

If the results of the execution of the verification program associated with the more abstract constituent requirement does not satisfy the condition for success, then it can be presumed that the fault is occurring at a point that corresponds to one of the individual constituent requirements obtained by replacement from the constituent requirements.

In the example shown in FIG. 19, the locations in the system corresponding to the constituent requirements associated with the edges marked with a cross are the locations that may have failed, and the locations in the system corresponding to the constituent requirements associated with the other edges are the locations that have not failed.

Also, the fault isolation system 1 may be provided with a display device (omitted in FIG. 8), and the fault isolation unit 109 may, for example, display the isolation results illustrated in FIG. 19 on the display device. As a result, the designer of the system can check the displayed result and grasp the part where a fault may have occurred and the part where no fault has occurred.

Also, a designer viewing the information shown in FIG. 19 can determine that the more abstract configuration of IP access between Terminal_A and Terminal_B is not likely to be satisfied due to a fault between Nic and subnet_C. This is because, when there is a fault between Nic and subnet_C, if going back to the constituent requirements before the replacement from the constituent requirement that indicates the relationship between Nic and subnet_C, the execution results of the verification programs associated with those constituent requirements (each constituent requirement to which a cross mark is added in FIG. 19) do not satisfy condition for success. However, it is not necessarily the case that the fault occurs only between Nic and subnet_C when the information shown in FIG. 19 is indicated. This is because there is a possibility that the fault occurs in multiple locations simultaneously. For example, even if a fault occurs simultaneously between Nic and subnet_C, and between subnet_A and subnet_B, the same isolation results as shown in FIG. 19 can be obtained.

In the above description, the verification program execution unit 107 causes the system to execute a verification program associated with a constituent requirement belonging to the set of constituent requirements that was first input to the configuration information generation unit 101, and if the execution result of the verification program is not success, the verification program execution unit 107 causes the system to execute verification program associated with constituent requirement for each constituent requirement included in the set of constituent requirements replaced from the constituent requirement.

The verification program execution unit 107 may cause the system to execute, for each individual constituent requirement included in the configuration information, a verification program associated with the constituent requirement. For example, the verification program execution unit 107 may sequentially select the individual constituent requirement included in the configuration information one by one, and the verification program execution unit 107, the verification result determination unit 108, and the fault isolation unit 109 may execute steps S106 to S108 for the verification program associated with the selected constituent requirement. This operation may be applied to the second example embodiment described below.

According to this example embodiment, when the configuration information generation unit 101 receives an input of a set of constituent requirements, it replaces the constituent requirement whose relationships between components are “abstract” with the set of constituent requirements according to the replacement rules, and stores a combination of the constituent requirement before the replacement and the set of constituent requirements after the replacement. The configuration information generation unit 101 repeats such replacement until the relationship contained in all the constituent requirements corresponds to “concrete”. As a result, the configuration information is obtained.

Then, the attribute value setting unit 105 sets the attribute values of the components included in the set of constituent requirements after replacement by the configuration information generation unit 101. Further, the verification program generation unit 106 generates a verification program for each of the constituent requirements included in the configuration information using the verification items and the attribute values set by the attribute value setting unit 105.

Thereafter, the verification program execution unit 107 causes the system to execute the verification program, the verification result determination unit 108 determines whether or not the execution result of the verification program satisfies the condition of success, and the fault isolation unit 109 separates the part in the system where the fault may have occurred from the part where the fault has not occurred according to the determination result.

Therefore, according to this example embodiment, it is possible to separate the part in the system where a fault may have occurred from the part where no fault has occurred.

### Example Embodiments 2

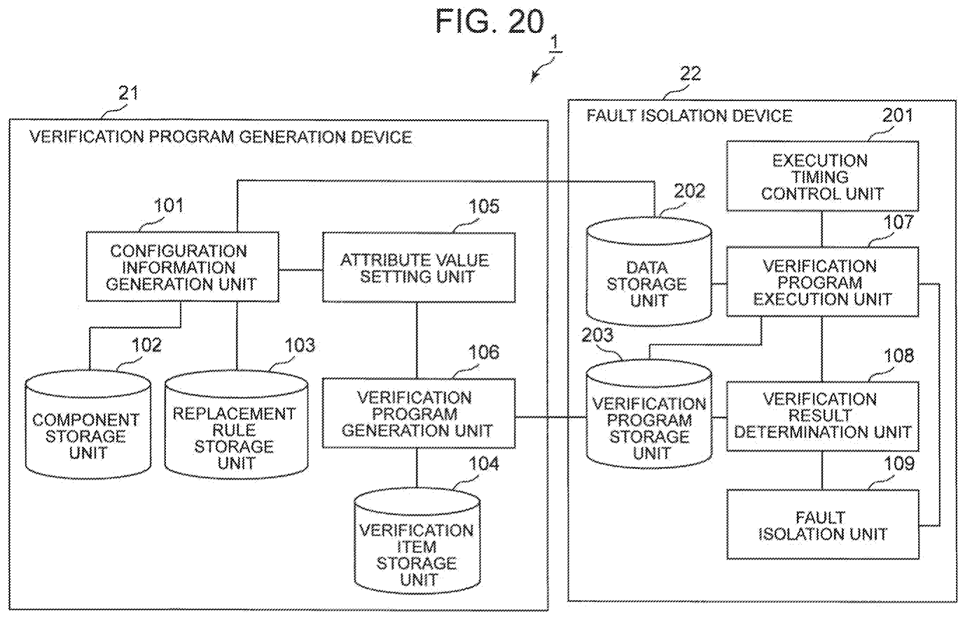

FIG. 20 is a block diagram showing an example configuration of a fault isolation system of the second example embodiment of the present invention. The same sign as in FIG. 8 is attached to the same elements as in the first example embodiment, and a detailed description is omitted.

The fault isolation system 1 of the second example embodiment includes a verification program generation device 21 and a fault isolation device 22. The verification program generation device 21 is a device that executes operations up to the generation of the verification program. The fault isolation device 22 is a device that executes an operation to separate a part in the system that may have a fault from a part that does not have a fault after generation of the verification program.

The verification program generation device 21 includes a configuration information generation unit 101, a component storage unit 102, a replacement rule storage unit 103, a verification item storage unit 104, an attribute value setting unit 105, and a verification program generation unit 106.

The fault isolation device 22 includes an execution timing control unit 201, a data storage unit 202, a verification program storage unit 203, a verification program execution unit 107, a verification result determination unit 108, and a fault isolation unit 109.

The configuration information generation unit 101, the component storage unit 102, the replacement rule storage unit 103, the verification item storage unit 104, the attribute value setting unit 105, and the verification program generation unit 106 are the same as those elements in the first example embodiment. The configuration information generation unit 101, the attribute value setting unit 105 and the verification program generation unit 106 perform the same operations as in steps S101 to S104 (see FIG. 11).

However, when the configuration information generation unit 101 replaces the constituent requirement with a set of more concrete constituent requirements based on the replacement rules, the combination of the constituent requirement before replacement and the set of constituent requirements after replacement is transmitted via the communication interface (omitted in FIG. 20) of the verification program generation device 21 to the fault isolation device 22 by the configuration information generation unit 101. When the fault isolation device 22 receives the information via the communication interface (omitted in FIG. 20) of the fault isolation device 22, it stores the information in the data storage unit 202.

Similarly, the configuration information generation unit 101 transmits the generated configuration information to the fault isolation device 22 via the communication interface of the verification program generation device 21. When the fault isolation device 22 receives the configuration information, it stores the configuration information in the data storage unit 202.

The data storage unit 202 is a storage device for storing information obtained in the process of the configuration information generation unit 101.

In addition, the verification program generation unit 106 transmits, for example, each time a verification program is generated, the combination of the generated verification program, the constituent requirement associated with the verification program, and the condition under which the execution result of the verification program is success via the communication interface of the verification program generation unit 21 to the fault isolation device 22. When the fault isolation device 22 receives the combination (combination of the verification program, the constituent requirement, and the condition under which the execution result of the verification program is success) via the communication interface of the fault isolation device 22, the fault isolation device 22 stores the combination in the verification program storage unit 203.

The verification program storage unit 203 is a storage device that stores a combination of the verification program, the constituent requirement, and the condition under which the execution result of the verification program is success.

The verification program execution unit 107, the verification result determination unit 108, and the fault isolation unit 109 provided in the fault isolation device 22 are the same as the verification program execution unit 107, the verification result determination unit 108, and the fault isolation unit 109 in the first example embodiment.

The execution timing control unit 201 causes the verification program execution unit 107 to start an operation to cause the system to execute the verification program at a predetermined timing. In other words, the execution timing control unit 201 provides the verification program execution unit 107 with a start trigger of the operation to cause the system to execute the verification program at a predetermined timing.

The verification program execution unit 107 executes the step S105 (see FIG. 12) when the execution timing control unit 201 provides the start trigger of the operation to cause the system to execute the verification program. That is, when the execution timing control unit 201 provides the start trigger to the verification program execution unit 107, the verification program execution unit 107, the verification result determination unit 108, and the fault isolation unit 109 use the data stored in the data storage unit 202 and the verification program stored in the verification program storage unit 203, and execute the processing from step S105 (see FIG. 12) onward.

The execution timing control unit 201 may provide the above-described start trigger to the verification program execution unit 107 periodically (every certain time), for example.

Alternatively, the execution timing control unit 201 may provide the above-described start trigger to the verification program execution unit 107 when a notification of an abnormality occurrence in the system is received from an external device via the communication interface of the fault isolation device 22.

The source of notification of the abnormality occurrence in a system may be the system itself, or a detection device that detects an abnormality in the system.

In the present example embodiment, the configuration information generation unit 101, the attribute value setting unit 105, and the verification program generation unit 106 are realized, for example, by a CPU of a computer that operates according to a program for the verification program generation device. In this case, the CPU may read the program for the verification program generation device from a program recording medium such as a program storage device of the computer, and operate as the configuration information generation unit 101, the attribute value setting unit 105, and the verification program generation unit 106 according to the program. The configuration information generation unit 101, the attribute value setting unit 105, and the verification program generation unit 106 may each be realized by individual hardware that is provided in a communicable manner.

The component storage unit 102, the replacement rule storage unit 103, and the verification item storage unit 104 are realized, for example, by a storage device provided by a computer.

The execution timing control unit 201, the verification program execution unit 107, the verification result determination unit 108, and the fault isolation unit 109 are realized, for example, by a CPU of a computer operating according to a program for the fault isolation device. In this case, the CPU may read the program for the fault isolation device from a program recording medium such as a program storage device of the computer, and operate as the execution timing control unit 201, the verification program execution unit 107, the verification result determination unit 108, and the fault severing unit 109 according to the program. The execution timing control unit 201, the verification program execution unit 107, the verification result determination unit 108, and the fault isolation unit 109 may each be realized by individual hardware that is provided in a communicable manner.

The data storage unit 202 and the verification program storage unit 203 are realized, for example, by a storage device provided by a computer.

In the second example embodiment, the same effects as those of the first example embodiment can be obtained. Also, according to the second example embodiment, the generation of the verification program and the isolation by the fault isolation unit 109 during system operation can be performed at different times.

Although FIG. 20 shows a case where the fault isolation system 1 is separated into two devices, a verification program generation device 21 and a fault isolation device 22, in the second example embodiment, the fault isolation system 1 may be realized by a single device.

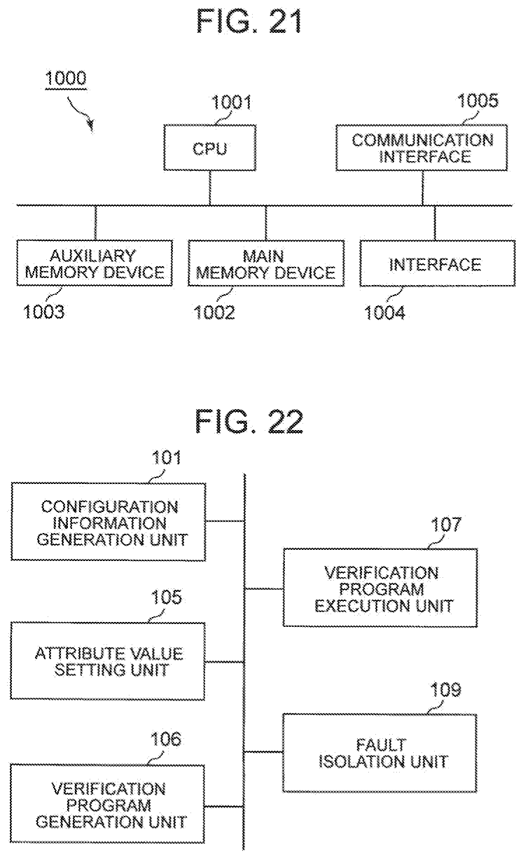

FIG. 21 is a schematic block diagram showing an example configuration of a computer pertaining to the fault isolation system 1 of the present invention, the verification program generation device 21 and the fault isolation device 22 in the second example embodiment. The computer 1000 includes a CPU 1001, a main memory device 1002, an auxiliary memory device 1003, an interface 1004, and a communication interface 1005.

The fault isolation system 1 of the present invention, the verification program generation device 21, and the fault isolation device 22 are each realized by a computer 1000. The operation of the fault isolation system 1, the operation of the verification program generation device 21, and the operation of the fault isolation device 22 are stored in the auxiliary storage device 1003 in the form of a program, and the CPU 1001 reads the program from the auxiliary storage device 1003, expands the program to the main memory device 1002, and executes the processing described in the above each example embodiment according to the program.

The auxiliary storage device 1003 is an example of a non-transitory tangible medium. Other examples of a non-transitory tangible medium include a magnetic disk, an optical magnetic disk, a CD-ROM (Compact Disk Read Only Memory), a DVD-ROM (Digital Versatile Disk Read Only Memory), semiconductor memory, and the like. When the program is delivered to the computer 1000 by a communication line, the computer 1000 receiving the delivery may expand the program into the main memory device 1002 and execute the processing (operation) described in each of the above example embodiments according to the program.

Some or all of each of the elements may be realized by general purpose or dedicated circuitry, processors, or combinations thereof. These may comprise a single chip or a plurality of chips connected via a bus. Some or all of each element may be realized by a combination of the above-described circuitry and the like and a program.

When some or all of each element is realized by a plurality of information processing apparatuses, circuits, or the like, the plurality of information processing apparatuses, circuits, or the like may be centrally located or distributed. For example, the information processing apparatuses, circuits, and the like may be implemented as a client-and-server system, a cloud computing system, and the like, each of which is connected via a communication network.

Next, an overview of the present invention will be described. FIG. 22 is a block diagram showing an overview of the fault isolation system of the present invention. The fault isolation system of the present invention includes a configuration information generation unit 101, an attribute value setting unit 105, a verification program generation unit 106, a verification program execution unit 107, and a fault isolation unit 109.

When given a set of constituent requirements, wherein the constituent requirement is information indicating a relationship between components, wherein the component is information representing a piece that constitutes a system by a predetermined data structure, the configuration information generation unit 101 generates configuration information representing the system, by repeating operation of replacing the constituent requirement with a set of more concrete constituent requirements according to a replacement rule.

The attribute value setting unit 105 sets an attribute value of the component included in set of constituent requirements after replacement in the configuration information.

Based on the attribute value, the verification program generation unit 106 generates, for each constituent requirement, a verification program for verifying whether parts in the system corresponding to the constituent requirement in the configuration information are normal or not.

The verification program execution unit 107 causes the system to execute the verification program.

The fault isolation unit 109 separates the part in the system where a fault may have occurred from the part where the fault has not occurred, according to whether execution result of the verification program is success or not.

Such a configuration makes it possible to separate a part in the system where a fault may have occurred from a part in the system where no fault has occurred.

The verification program execution unit 107 may cause the system to execute the verification program associated with the constituent requirement belonging to the set of constituent requirements that was first given, and repeat, in case the execution result of the verification program is not success, operation of causing the system to execute the verification program associated with the constituent requirement, for each constituent requirement belonging to the set of constituent requirements replaced from the constituent requirement.

The verification program execution unit 107 may cause the system to execute the verification program associated with the constituent requirement, for each individual constituent requirement included in the configuration information.

The fault isolation system may also comprise an execution timing control unit (e.g., the execution timing control unit 201) that causes the verification program execution unit to start operation of causing the system to execute the verification program at a predetermined timing.

The fault isolation system may also comprise a verification item storage unit (e.g., verification item storage unit 104) unit that stores a verification item that is information describing an instruction to be executed by the system using a variable, the verification item being according to types of constituent requirements, wherein the attribute value setting unit 105, for each constituent requirement after replacement in the configuration information, uses attribute value constraint condition associated with the replacement rule used for deriving the constituent requirement, and sets the attribute value of the component included in the constituent requirement after replacement, and the verification program generation unit 106 generates, for each constituent requirement in the configuration information, the verification program associated with the constituent requirement, by assigning the attribute value of the component included in the constituent requirement to the variable described in the verification item according to type of the constituent requirement.

Although the present invention has been described above with reference to example embodiments, the present invention is not limited to the above example embodiments. Various changes may be made to the structure and details of the present invention that may be understood by those skilled in the art within the scope of the present invention.

### INDUSTRIAL APPLICABILITY

The present invention is suitably applied for separating a part where a fault may have occurred from a part where no fault has occurred.

### REFERENCE SIGNS LIST

1 Fault isolation system
21 Verification program generation device
22 Fault isolation device
101 Configuration information generation unit
102 Component storage unit
103 Replacement rule storage unit
104 Verification item storage unit
105 Attribute value setting unit
106 Verification Program generation unit
107 Verification program execution unit
108 Verification result determination unit
109 Fault isolation unit
201 Execution timing control unit
202 Data storage unit
203 Verification program storage unit

What is claimed is:

1. A fault isolation system comprising:
a configuration information generation unit, when given a set of constituent requirements, wherein the constituent requirement is information indicating a relationship between components, wherein the component is information representing a piece that constitutes a system by a predetermined data structure, generates configuration information representing the system, by repeating operation of replacing the constituent requirement with a set of more concrete constituent requirements according to a replacement rule;
an attribute value setting unit that sets an attribute value of the component included in set of constituent requirements after replacement in the configuration information;
a verification program generation unit that generates, for each constituent requirement, a verification program for verifying whether parts in the system corresponding to the constituent requirement in the configuration information are normal or not, based on the attribute value;
a verification program execution unit that causes the system to execute the verification program; and
a fault isolation unit that separates the part in the system where a fault may have occurred from the part where the fault has not occurred, according to whether execution result of the verification program is success or not.

2. The fault isolation system according to claim 1,
wherein verification program execution unit
causes the system to execute the verification program associated with the constituent requirement belonging to the set of constituent requirements that was first given, and
repeats, in case the execution result of the verification program is not success, operation of causing the system to execute the verification program associated with the constituent requirement, for each constituent requirement belonging to the set of constituent requirements replaced from the constituent requirement.

3. The fault isolation system according to claim 1,
wherein the verification program execution unit
causes the system to execute the verification program associated with the constituent requirement, for each individual constituent requirement included in the configuration information.

4. The fault isolation system according to claim 1, further comprising:
an execution timing control unit that causes the verification program execution unit to start operation of causing the system to execute the verification program at a predetermined timing.

5. The fault isolation system according to claim 1, further comprising:
a verification item storage unit that stores a verification item that is information describing an instruction to be executed by the system using a variable, the verification item being according to types of constituent requirements,
wherein the attribute value setting unit,
for each constituent requirement after replacement in the configuration information, uses attribute value constraint condition associated with the replacement rule used for deriving the constituent requirement, and sets the attribute value of the component included in the constituent requirement after replacement, and
the verification program generation unit
generates, for each constituent requirement in the configuration information, the verification program associated with the constituent requirement, by assigning the attribute value of the component included in the constituent requirement to the variable described in the verification item according to type of the constituent requirement.

6. A fault isolation method comprising:
when given a set of constituent requirements, wherein the constituent requirement is information indicating a relationship between components, wherein the component is information representing a piece that constitutes a system by a predetermined data structure, generating configuration information representing the system, by repeating operation of replacing the constituent requirement with a set of more concrete constituent requirements according to a replacement rule;
setting an attribute value of the component included in set of constituent requirements after replacement in the configuration information;
generating, for each constituent requirement, a verification program for verifying whether parts in the system corresponding to the constituent requirement in the configuration information are normal or not, based on the attribute value;
causing the system to execute the verification program; and
separating the part in the system where a fault may have occurred from the part where the fault has not occurred, according to whether execution result of the verification program is success or not.

7. A non-transitory computer-readable recording medium in which a fault isolation program is recorded, the fault isolation program causing a computer to execute:
a configuration information generation process of, when given a set of constituent requirements, wherein the constituent requirement is information indicating a relationship between components, wherein the component is information representing a piece that constitutes a system by a predetermined data structure, generating configuration information representing the system, by repeating operation of replacing the constituent requirement with a set of more concrete constituent requirements according to a replacement rule;
an attribute value setting process of setting an attribute value of the component included in set of constituent requirements after replacement in the configuration information;
a verification program generation process of generating, for each constituent requirement, a verification program for verifying whether parts in the system corresponding to the constituent requirement in the configuration information are normal or not, based on the attribute value;
a verification program execution process of causing the system to execute the verification program; and
a fault isolation process of separating the part in the system where a fault may have occurred from the part where the fault has not occurred, according to whether execution result of the verification program is success or not.
